(19) United States
(12) Patent Application Publication
(10) Pub. No.: US 2009/0053996 A1
(43) Pub. Date: Feb. 26, 2009

(54) Active Signal Interference

(76) Inventors: Jean Pierre Enguent, Aix en Provence (FR); Romain Palmade, Auriol (FR)

Correspondence Address: FISH & RICHARDSON P.C., PO BOX 1022, MINNEAPOLIS, MN, 55440-1022, US

(21) Appl. No.: 11/841,330

(22) Filed: Aug. 20, 2007

(51) Int. Cl. H04B 1/06

(52) U.S. Cl. 455/26.1

(57) ABSTRACT

The subject matter of this specification can be embodied in, among other things, a circuit that includes a power module that includes an antenna. The power module is configured to generate power from a carrier signal received by the antenna. The circuit also includes a subcarrier generator powered by the power module when the carrier signal is received regardless of a communication protocol used in transmitting the carrier signal. The subcarrier generator generates an obscuring signal configured to obscure an information signal generated by another circuit energized by the carrier signal.

### TECHNICAL FIELD

The present invention relates to securing communications.

### BACKGROUND

Wireless devices, such as radio frequency identification (RFID) tags, can be attached to goods and other objects to provide information. Some RFID tags are passive and do not include internal power sources. Instead, a passive RFID tag is powered when it receives a RF signal from a RF reader. In response to the RF signal from the RF reader, the RFID tag can transmit information stored in the RFID tag, such as an identifier or information about a person or goods associated with the RFID tag.

RFID tags may be subject to unauthorized reads. For example, a high-powered RF reader can transmit a signal that energizes a RFID tag from a distance. The RF reader may then read the information from the RFID tag covertly. Additionally, high-powered RF readers may be able to overcome some RFID security measures, such as passive shields, which block RF fields from reaching the RFID tags. For example, the high-powered RF reader may be able to provide enough power to energize the RFID tag despite the passive shield's blocking attributes.

### SUMMARY

In general, this document describes preventing unauthorized communications with a device, such as a radio frequency (RF) device.

In a first general aspect, a circuit is described. The circuit includes a power module that includes an antenna. The power module is configured to generate power from a carrier signal received by the antenna. The circuit also includes a subcarrier generator powered by the power module when the carrier signal is received regardless of a communication protocol used in transmitting the carrier signal. The subcarrier generator generates an obscuring signal configured to obscure an information signal generated by another circuit energized by the carrier signal.

In a second general aspect, a system is described. The system includes an information circuit comprising a transponder for receiving a radio frequency (RF) carrier signal from a RF reader and transmitting an information signal having information in response to the RF carrier signal. The system also includes a blocking circuit that includes a transponder for receiving the RF carrier signal and transmitting an obscuring signal in response to the RF carrier signal regardless of a communication protocol used by the RF reader for transmission of the RF carrier signal. The obscuring signal prevents the RF reader from extracting the information from the information signal.

In yet another general aspect, a method is described. The method includes receiving, at a first circuit, a carrier signal to energize the first circuit, and transmitting—regardless of a communication protocol used in transmission of the carrier signal—a blocking signal at a frequency to interfere with an information signal transmitted by a second circuit energized by the carrier signal.

The systems and techniques described here may provide none, one, or more of the following advantages. First, radio frequency (RF) communications between RF devices and RF readers can be obscured regardless of the transmitting power of the RF reader. Additionally, an obscuring signal can be transmitted regardless of the communication protocol used by the RF reader. The systems and methods can also decrease manufacturing costs because of the simplicity in the implementation. For example, an internal power source or a microprocessor is not needed to generate an obscuring signal.

The details of one or more implementations of the invention are set forth in the accompanying drawings and the description below. Other features and advantages of the invention will be apparent from the description and drawings, and from the claims.

### DESCRIPTION OF DRAWINGS

FIGS. 1A and 1B are box diagrams of an example system for permitting and obscuring communications, respectively.

FIG. 2 is a flow chart of an example method for obscuring communications.

FIG. 3 is a schematic of an example circuit used for obscuring communications.

FIG. 4 are example signal diagrams of information and obscuring signals.

FIGS. 5A and 5B are schematics of example structures having embedded obscuring circuitry.

Like reference symbols in the various drawings indicate like elements.

### DETAILED DESCRIPTION

This document describes example systems and techniques for obscuring communications between, for example, a radio frequency (RF) reader and a RF identification (ID) tag. In certain implementations, an active shield is placed near a RF device, such as a RFID tag embedded in a passport. A RF reader can transmit a RF carrier signal that energizes both the RF device and the active shield. In response, the RF device transmits information to the reader using a subcarrier frequency imposed on the carrier frequency. The active shield also transmits a signal on the subcarrier frequency, however, the signal can include spurious, arbitrary, or random data. The signal from the active shield can interfere with the signal from the RF device so that the RF reader may not accurately read the signal transmitted by the RF device.

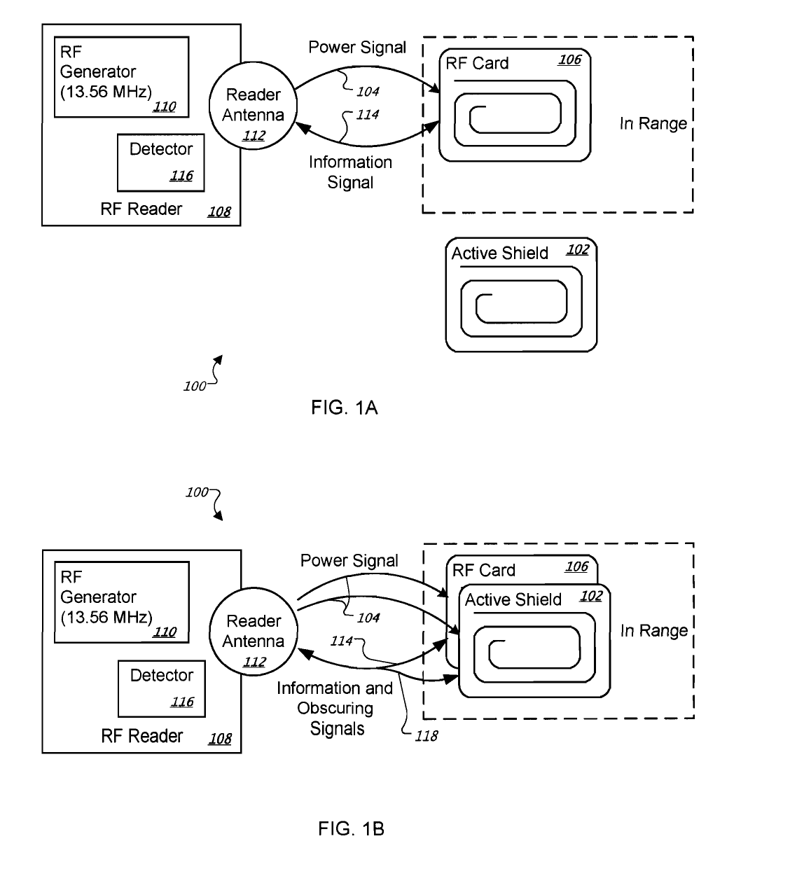

FIGS. 1A and 1B are box diagrams of an example system 100 that permits and obscures communications, respectively. FIG. 1A shows the system 100, where the active shield 102 is out of range relative to the power signal 104 used to energize a RF card 106. The system includes a RF reader 108 that transmits the power signal 104 to the RF card 106.

In certain implementations, the RF reader 108 includes a RF generator 110 that generates the power signal 104. For example, the RF generator 110 can generate a radio frequency signal, such as a high frequency (HF) signal of 13.56 MHz. Additionally, in certain implementations, the RF generator 110 can generate signals at different frequencies, such as 125-134.2 kHz, 140-148.5 kHz, and 868 MHz-928 MHz, in addition to or instead of generating the 13.56 MHz signal. Additionally, other frequencies generated by, for example, load modulation, can be used. For the purposes of illustration, the examples described use 13.56 MHz signals, although this is not intended to be limiting.

The RF generator 110 can send the generated signal to a reader antenna 112 for transmission to the RF card 106. As described previously, the generated signal, or power signal 104, can energize, or power, the RF card 106. In some implementations, the RF card transmits information in response to the received power signal 104. This information can include, for example, passport information, information about goods associated with the tag, medical information, etc. In certain implementations, the information can be encoded in an information signal 114 that is transmitted using a backscatter signal, or subcarrier signal, that is transmitted back to the RF reader.

In FIG. 1A, the active shield 102 is outside the range of the power signal 104 transmitted by the RF reader 108. Because the active shield 102 is out of range, it is not energized by the power signal 104 and does not transmit a signal back to the RF reader 108.

The reader antenna 112 of the RF reader 108 can receive the information signal 114. As shown in FIG. 1, the RF reader 108 can use a detector 116 to extract and decode information embedded in the information signal 114. For example, the RF card 106 may be embedded in a passport. The RF reader 108 is positioned close enough to the passport to energize the embedded RF card 106 with a carrier signal. In response to the carrier signal transmitted by the RF reader 108, the RF card 106 can respond with a subcarrier signal imposed on the carrier signal. The subcarrier signal may include information related to the passport, such as a passport holder's name, date of birth, and citizenship. The reader antenna 112 receives the subcarrier signal, and the detector 116 extracts the passport information for use in other applications, such as displaying the passport information to a user.

FIG. 1B shows the system 100, where the active shield 102 is within a range of the power signal 104 transmitted by the RF reader 108. Here, the power signal 104 is received and powers both the RF card 106 and the active shield 102. In certain implementations, the energized RF card 106 transmits the information signal 106 as described above, however, the active shield 102 can also transmit an obscuring signal 118 that prevents the RF reader 108 from decoding the information signal 114.

For example the obscuring signal 118 may be transmitted on substantially a same frequency as the information signal 114, as indicated by the joined arrow shown in FIG. 1B. The reader antenna 112 receives the signals, but may be unable to extract information from the signal because the received signal includes components from the obscuring signal and the information signal.

In some implementations, the obscuring signal 118 is transmitted in response to the power signal 104, regardless of communication protocols used by the RF reader to transmit the power signal 104. For example, regardless of whether the RF reader transmits a carrier signal using ISO (International Organization for Standardization) 15693, ISO 18000-3C, ISO 14443, various anti-collision protocols, etc., the active shield 102 can respond with an obscuring signal without having to decode the received carrier signal.

In some implementations, the obscuring signal may prevent unauthorized reads of the RF card 106. For example, a malicious user may use a high-powered (e.g., 100 W or higher) RF reader to gain unauthorized access to information stored in a RFID tag. Because of the high power, the RF reader may energize the RFID tag from a distance to avoid detection of the unauthorized attempt to read. If the high-powered reader energizes the RFID tag, an active shield placed near the RFID tag also may be energized. The energized RFID tag and active shield may then respond with an information signal and an obscuring signal, respectively. In this example, the high-powered RF reader may not successful read the RFID tag because the obscuring signal masks the information present in the information signal.

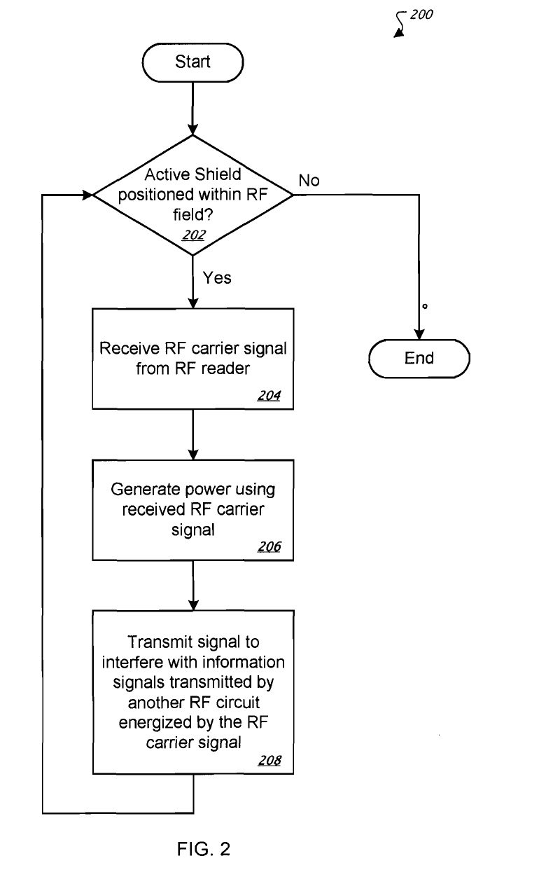

FIG. 2 is a flow chart of an example method 200 for obscuring communications. The method 200 can be performed by an active shield, such as the active shield 102 shown in FIG. 1. In step 202, it is determined whether an active shield is positioned within a RF field. For example, the active shield 102 can be positioned so that it is near a RFID tag that is embedded in a credit card. A RF reader can transmit a RF signal that generates a field that includes the active shield and the RFID tag. In this case, the method 200 moves to step 204. If the active shield is not within a RF field, the method 200 can end.

In step 204, the RF carrier signal is received from the RF reader. For example, the active shield can include an antenna, which receives the RF carrier signal. In step 206, the active shield is energized using the RF carrier signal. For example, the antenna can use the received carrier signal to power the active shield components. In some implementations, the power can be rectified before it is used by the active shield components.

In step 208, a signal is transmitted, which interferes with information signals transmitted by other RF circuits that are energized by the RF carrier signal. For example, the active shield can include an oscillator (e.g., a crystal oscillator) that generates a signal with arbitrary data, where the signal has the same frequency as an information signal transmitted by a RFID tag. The transmission of the obscuring signal may continue as long as the active shield is within the RF field, as indicated in step 202. If the RF field is removed, the method 200 can end.

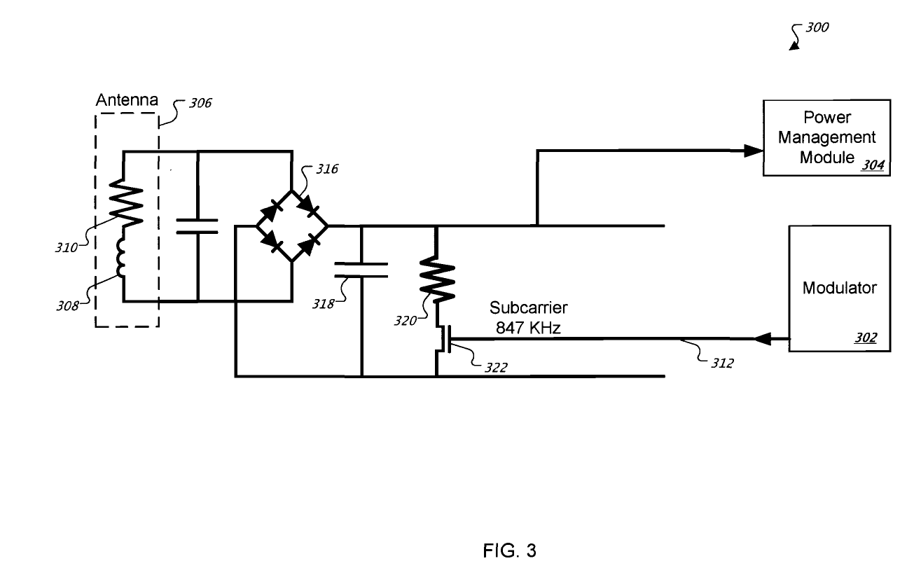

FIG. 3 is a schematic of an example circuit 300 used for obscuring communications. The implementation of FIG. 3 includes a contactless interface, a modulator 302, and optionally, a power management module 304. The contactless interface can include an antenna 306 having an inductor 308 and a resistor 310. The circuit 300 can use the antenna to receive and transmit signals, such as the RF carrier and subcarrier signals described above.

The modulator 302 can generate a subcarrier signal 312, such as an example 847 kHz signal. The modulator can generate the signal as soon as the circuit 300 is energized by the carrier signal received by the antenna. In some implementations, the modulator continues to generate the subcarrier signal as long as the circuit 300 is powered.

The modulator can be designed to generate a subcarrier that has the same frequency as subcarrier submitted by other RF circuits, such as RFID tags, or cards. In some implementations, the subcarrier generated by the modulator 302 obfuscates information embedded in subcarriers generated by the other RF circuits so that a RF reader may not read the information from other subcarriers.

In some implementations, the modulator can generate more than one frequency. This may permit using the circuit 300 in several different RF communication schemes that have different subcarrier frequencies. For example, the modulator 302 may generate two subcarrier signals simultaneously, where one signal has a frequency of 847 kHz and the other signal has a frequency of 106 kHz. By generating both frequencies, the circuit 300 can interfere with RF communications using either or both of the frequencies.

In some implementations, the modulator generates a single subcarrier when powered. A user can select the frequency of the subcarrier through, for example, the adjustment of a variable resistor.

FIG. 3 shows an implementation that includes a power management module 304 that can be used to distribute or regulate power to the circuit 300. For example, the power management module 304 can regulate the power generated from the carrier signal so that it maintains a substantially constant voltage. The regulated power signal then can be transmitted for use by the modulator 302. In another example, the power management module can be used to step up or step down voltage generated from the received RF carrier signal.

In certain implementations, the power management module 304 can also include components that store energy generated by the carrier signal for later use. For example, the power management module can include capacitors that store energy that may be used to power the modulator 302 even if the carrier signal stops.

Additionally, in certain implementations, the circuit 300 includes components to rectify and smooth the carrier signal transmitted as a sine wave. For example, the carrier signal can be rectified by a bridge rectifier 316. The rectified carrier signal can, in some implementations, then be smoothed by an RC filter including a capacitor 318 and a resistor 320. The rectified and smoothed carrier signal may approximate a direct current (DC) voltage that is transmitted to the power management module 304, the modulator 302, or both.

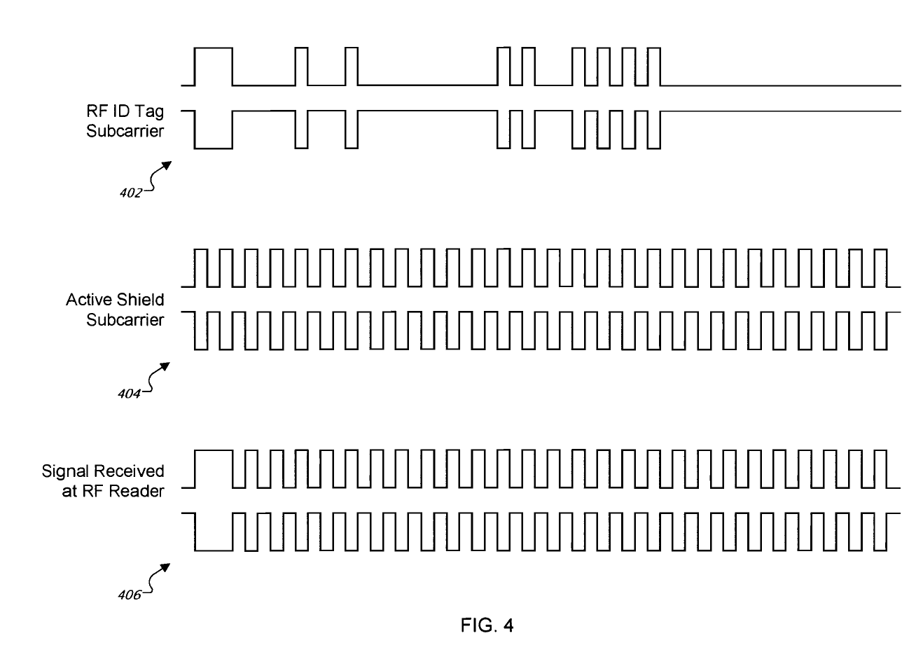

FIG. 4 shows example signal diagrams of information and obscuring signals. Signal 402 is an example of an information signal generated by a RFID tag, or card, in response to a carrier signal received by the tag. In some implementations, information can be embedded in the signal, for example, using amplitude-shift-keying (ASK) modulation. The signal may be continually “on,” and its amplitude modulated to convey the information. In other implementations, information may be embedded using other protocols that do not require the signal to continually transmit. For example, a RFID tag can include a modulator that switches the signal on and off to convey the information.

Signal 404 is an example of an obscuring signal transmitted by an active shield. The obscuring signal 404 can include meaningless or arbitrary data. In the example shown in FIG. 4, every period has a modulated amplitude. The obscuring signal 404 can occur at the same frequency as the information signal 402. In other implementations, the obscuring signal 404 can occur at a frequency that differs from the information signal 402. For example, the obscuring signal 404 can have a frequency that is a multiple of the information signal's frequency.

Signal 406 is an example of a composite signal 406 received at a RF reader. In some implementations, the composite signal is a combination of the obscuring signal and the information signal 402. The composite signal is received by a RF reader, but the information may not be extracted because the obscuring signal has—in this case—added information which may not be distinguished from the information embedded in the information signal.

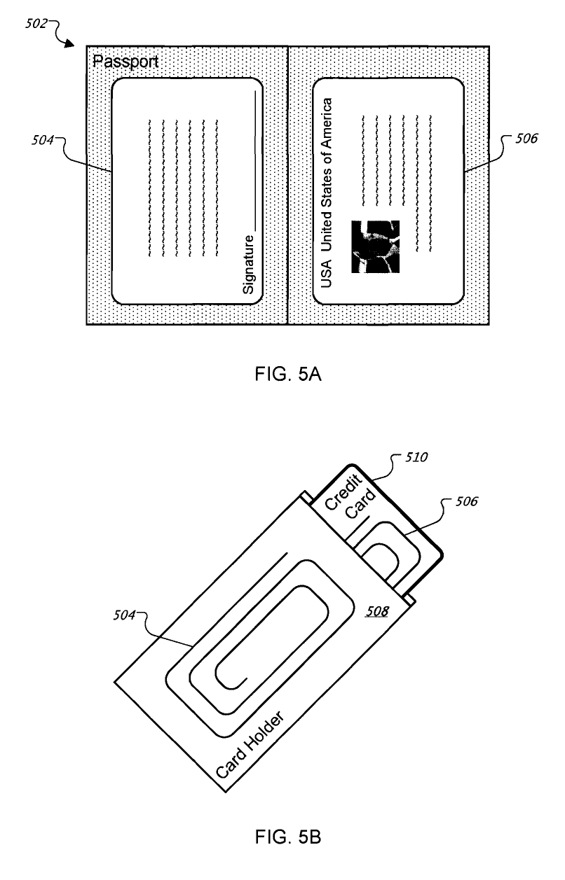

FIGS. 5A and 5B are schematics of example structures having embedded obscuring circuitry. As described previously, in certain implementations, an active shield blocks information transmitted by RF cards, etc., when located close enough to the card to be activated by the carrier signal that also activates the RF device. When the active shield is located outside the RF field, or carrier signal field, the active shield does not transmit an obscuring signal that interferes with the RF device's information signal.

In certain implementations, an active shield and RF device can be embedded in a structure, such as within a passport, so that the active shield prevents unauthorized reads when the active shield is positioned sufficiently near the RF device (e.g., near enough so that it is powered by a carrier signal when the RF device is powered). FIG. 5A shows a passport 502. In certain implementations, the unauthorized reads are prevented when the passport is closed because the active shield is positioned near the RF device. In certain implementations, the RF device, however, can be read when the passport is opened. Opening the passport moves the active shield away from the RF device so that a reader can transmit a RF signal to the RF device without energizing the active shield. In this example, the unpowered active shield does not transmit an obscuring signal to interfere with the information signal transmitted by the RF device.

By manipulating the position of the active shield in relation to the RF device, a user can select whether or not reads of the RF device are permitted. In the example of FIG. 5A, the user can open the passport 502 so that a RF reader can be placed near the embedded RF device 506. The RF field generated by the RF reader may energize the RF device (causing the RF device to respond with an information signal) without energizing the active shield because the active shield is outside of the RF field.

When a user wants to prevent readers from accessing the information in the RF device, the user can close the passport, which places the active shield near the RF device. If a read is attempted, the RF field generated by the RF reader energizes both the RF device and the active shield, which can prevent the RF reader from accurately decoding information transmitted by the RF device because an obscuring signal is transmitted from the activated active shield.

FIG. 5B shows another example structure that includes an embedded active shield, where the RF device can be placed within the structure if, for example, a user wishes to prevent reading the RF device from being read. In this example, the active shield 504 is embedded in or attached to a card holder 508.

In certain implementations, the RF device can be part of a card 510, for example, an identification card, a medical card, or a credit card, etc. When the card 510 is outside of the card holder 508, the card can be read by a RF reader if it is sufficiently far from the card holder 508 so that the card holder 508 is not within a RF field created by the RF reader. In certain implementations, if a user wishes to prevent reads from the RF device 506 embedded in the card 510, the user may insert the card 508 into the card holder 510. When inserted, the embedded RF device 506 can be positioned sufficiently near the active shield 504 of the card holder 508 so that both the active shield 504 and RF device 506 are powered when the RF reader attempts to read information from the RF device 506. The activated active shield 504 can then transmit an obscuring signal that interferes with the RF reader's ability to read information from an information signal transmitted by the RF device 506.

Although a few implementations have been described in detail above, other modifications are possible. For example, in some implementations, additional components may be used in the example circuit 300 used to generate obscuring signals. For example, the circuit 300 can include a capacitor 322 that prevents the rectified and smoothed carrier signal from traveling through the line used to transmit the subcarrier signal while still permitting the alternating current (AC) subcarrier signal to pass through.

In other implementations, the circuit 300 can handle high power energy, such as high-powered RF signals received from a high-powered RF reader (e.g., 100 W). In some instances, high-powered RF readers may be used in an attempted unauthorized read of an RFID tag. In one implementation, the excessive power can be limited using an adjustable load. For example, a resistive load can be placed in parallel with the capacitor 318 and driven by the power management module 304.

In some implementations, the active shield can include components that indicate whether an obscuring signal is transmitted. For example, if the active shield is energized, a status indicator can visually indicate the active shield is activated. In some implementations, the status indicator includes one or more light emitting diodes (LEDs). For example, a red colored LED can light when the active shield is powered. In another implementation, a display attached or incorporated into the active shield can indicate a status associated with active shield. For example, the active shield can include a liquid crystal display screen that displays a status, such as “ACTIVE,” or “UNAUTHORIZED READ ATTEMPT.” The screen may also display other information, such as how long it has been active, identification information about the RF reader transmitting the RF signals, the strength of the received RF signal, etc.

In addition, the logic flows depicted in FIG. 3 does not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A circuit comprising:
a power module comprising an antenna, the power module to generate power from a carrier signal received by the antenna; and
a subcarrier generator powered by the power module when the carrier signal is received regardless of a communication protocol used in transmitting the carrier signal, wherein the subcarrier generator generates an obscuring signal configured to obscure an information signal generated by another circuit energized by the carrier signal.

2. The circuit of claim 1, wherein the carrier, obscuring, and information signals comprise radio frequency signals.

3. The circuit of claim 1, wherein the obscuring and information signals have substantially the same frequency.

4. The circuit of claim 3, wherein the frequency is approximately 847 kHz.

5. The circuit of claim 1, wherein the antenna transmits the obscuring signal at substantially the same time as the other circuit energized by the carrier signal transmits the information signal.

6. The circuit of claim 1, wherein the power module further comprises a voltage regulator to regulate the power provided to the subcarrier generator.

7. The circuit of claim 1, wherein the subcarrier generator comprises an oscillator to generate the obscuring signal.

8. The circuit of claim 1, wherein the other circuit energized by the carrier signal is a radio frequency identification tag.

9. The circuit of claim 1, wherein the antenna transmits the obscuring signal imposed on the carrier signal to a device that transmitted the carrier signal.

10. The circuit of claim 9, wherein the device comprises a radio frequency reader.

11. The circuit of claim 1, further comprising a status indicator to indicate whether the obscuring signal is transmitted.

12. The circuit of claim 11, wherein the status indicator comprises one or more light emitting diodes or a liquid crystal display.

13. The circuit of claim 1, further comprising a microcontroller and a storage device, wherein the microcontroller logs information associated with the generating of the obscuring signal.

14. The circuit of claim 1, wherein the obscuring signal comprises arbitrary data.

15. The circuit of claim 1, wherein the obscuring signal comprises a predetermined informational response.

16. The circuit of claim 1, wherein the carrier signal has a frequency substantially equal to 13.56 MHz.

17. The circuit of claim 1, wherein the information signal has a frequency generated by load modulation.

18. A system comprising:
an information circuit comprising a transponder for receiving a radio frequency (RF) carrier signal from a RF reader and transmitting an information signal having information in response to the RF carrier signal; and
a blocking circuit comprising a transponder for receiving the RF carrier signal and transmitting an obscuring signal in response to the RF carrier signal regardless of a communication protocol used by the RF reader for transmission of the RF carrier signal, the obscuring signal preventing the RF reader from extracting the information from the information signal.

19. The system of claim 18, further comprising a structure in which the information and blocking circuits are embedded.

20. The system of claim 19, wherein the structure is configured to permit a user to position the blocking circuit within a distance from the information circuit so that the blocking circuit is energized by the RF carrier signal when the information circuit is energized by the RF carrier signal.

21. The system of claim 20, wherein the structure is configured to permit a user to position the blocking circuit outside the distance.

22. The system of claim 18, wherein the obscuring signal prevents the RF reader from extracting the information by interacting with the information signal so that the RF reader receives a composite signal comprising at least a portion of the obscuring signal and at least a portion of the information signal.

23. A method comprising:
receiving, at a first circuit, a carrier signal to energize the first circuit; and
transmitting, regardless of a communication protocol used in transmission of the carrier signal, a blocking signal at a frequency to interfere with an information signal transmitted by a second circuit energized by the carrier signal.
